(19) United States
(12) Patent Application Publication
(10) Pub. No.: US 2020/0371455 A1
(43) Pub. Date: Nov. 26, 2020

(54) PRESSING DRIVE MECHANISM AND IMAGE FORMING APPARATUS

(71) Applicant: Konica Minolta, Inc., Tokyo (JP)

(72) Inventors: Masahito TAKANO, Tokyo (JP); Jun ONISHI, Tokyo (JP); Takashi FUJIWARA, Tokyo (JP)

(21) Appl. No.: 16/849,488

(22) Filed: Apr. 15, 2020

(30) Foreign Application Priority Data
May 23, 2019 (JP) 2019-096573

(51) Int. Cl. G03G 15/16

(52) U.S. Cl. CPC G03G 15/1615

(57) ABSTRACT

A pressing drive mechanism, which drives a secondary transfer roller to press an intermediate transfer belt, includes: a motor that generates a driving force for driving the secondary transfer roller in a driving direction; a transmission mechanism that transmits the driving force to the secondary transfer roller to drive the secondary transfer roller in the driving direction; a hardware processor that controls the driving force of the motor to control a position in the driving direction of the secondary transfer roller; and a biasing member that biases the secondary transfer roller in a direction of pressing the intermediate transfer belt. The hardware processor controls the driving force of the motor in synchronization with a timing at which a front end of a sheet reaches the secondary transfer roller; and drives the secondary transfer roller to a predetermined pressing position by using a biasing force by the biasing member.

### CROSS-REFERENCE TO RELATED APPLICATIONS

The entire disclosure of Japanese Patent Application No. 2019-096573 filed on May 23, 2019 is incorporated herein by reference in its entirety.

### BACKGROUND

### Technological Field

The present invention relates to a pressing drive mechanism and an image forming apparatus.

### Description of the Related Art

Conventionally known image forming apparatuses are tandem ones that include image processing units for a plurality of colors such as Y (yellow), M (magenta), C (cyan), and K (black) side by side, form a single color toner image of respective colors on a photoreceptor of each of the image processing units, and sequentially transfer the single color toner image of respective colors to compose a color image on a sheet.

Such image forming apparatuses as described above have been required to be compatible with various kinds of sheets in recent years. Especially, there has been an increasing need for compatibility with a thick sheet used for a package, and the like. A key problem in using a thick sheet is the occurrence of streaks and unevenness in an image which is caused by the speed variation of an intermediate transfer belt due to vibrations and the like in entry to a secondary transferer.

To solve the above problem, a technique has been disclosed in which a thickness sensor that detects the thickness of a sheet and a distance sensor that detects the position of a secondary transfer roller are provided and the position of the secondary transfer roller is adjusted in a state of an eccentric cam abutting against a swing arm that swingably holds the secondary transfer roller, based on a detection result obtained by the distance sensor and thickness sensor in a state of the eccentric cam not abutting against the swing arm (for example, refer to JP2009-198596A). A technique described in JP2009-198596A allows the speed variation of an intermediate transfer belt in entry to a secondary transferer to be prevented.

### SUMMARY

However, a problem in the above technique described in JP2009-198596A is that it is necessary to provide a distance sensor that detects the position of a secondary transfer roller and accordingly it is costly and leads to a complicated device.

In addition, to grasp the abutting state of the eccentric cam against the swing arm, it is necessary to distinguish between “a cam angle area in which a detection result of the distance sensor changes along with the rotation of the eccentric cam in a sufficiently large rotation of the eccentric cam” and “a cam angle area in which a detection result of the distance sensor is constant irrespective of the rotation of the eccentric cam.” However, it is difficult to distinguish between the above cam angle areas during the operation of passing a sheet and consequently, it is impossible to grasp a short-term change in the diameter of the secondary transfer roller due to a temperature change, a crush, or the like. In order to stably obtain a pressing load by a spring in this situation, it is necessary to rotate the eccentric cam excessively so as to make sure that the eccentric cam retracts from the swing arm; and too much time is taken from retraction of the secondary transfer roller immediately before entry of a sheet to re-pressing and therefore, a transfer failure area may be generated at a front end of the sheet.

An object of the present invention, which has been made in view of the above problem, is to provide a pressing drive mechanism and image forming apparatus capable of preventing a transfer failure to a sheet by performing a pressing operation of a secondary transfer roller at low cost and in a short time.

To achieve at least one of the abovementioned objects, according to an aspect of the present invention, a pressing drive mechanism is provided which drives a secondary transfer roller, which secondarily transfers a toner image on a sheet by being pressed and rotated by an intermediate transfer belt on which the toner image is primarily transferred, to press the intermediate transfer belt. The pressing drive mechanism includes: a motor that generates a driving force for driving the secondary transfer roller in a driving direction that is orthogonal to an image transfer surface of the sheet; a transmission mechanism that transmits the driving force generated by the motor to the secondary transfer roller to drive the secondary transfer roller in the driving direction; a hardware processor that controls the driving force of the motor so as to control a position in the driving direction of the secondary transfer roller; and a biasing member that biases the secondary transfer roller in a direction of pressing the belt. The hardware processor controls the driving force of the motor in synchronization with a timing at which a front end of the sheet reaches the secondary transfer roller, and also drives the secondary transfer roller to a predetermined pressing position by using a biasing force by the biasing member.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are no intended as a definition of the limits of the present invention, wherein:

FIG. 1 is a block diagram showing a functional configuration of an image forming apparatus according to an embodiment;

FIG. 2 shows a schematic configuration of an image former according to the embodiment;

FIG. 3 is a flowchart showing secondary transfer roller driving control processing; and

FIG. 4 is a graph showing displacement of an axial center position of a secondary transfer roller when the secondary transfer roller driving control processing is executed.

### DETAILED DESCRIPTION OF THE EMBODIMENTS

Hereinafter, one or more embodiments of the present invention will be described with reference to the drawings. However, the scope of the invention is not limited to the disclosed embodiments.

First, description for the configuration of an embodiment will be given.

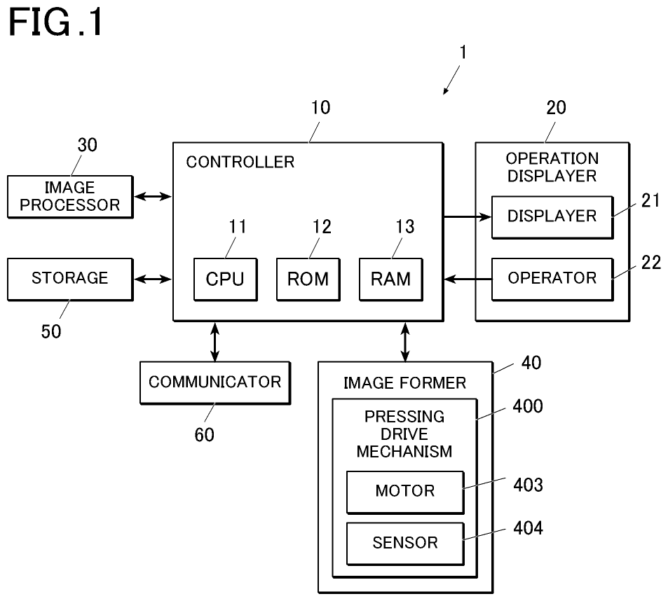

An image forming apparatus 1 according to the embodiment is a color image forming apparatus using the electrophotographic process technology. The image forming apparatus 1 includes, as shown in FIG. 1, a controller 10, an operation displayer 20, an image processor 30, an image former 40, a storage 50, and a communicator 60, which are connected via an unillustrated bus.

The controller 10 (driving controller, hardware processor) is constituted of a CPU 11, an ROM 12, an RAM 13, and the like. The CPU 11 of the controller 10 reads a system program and various processing programs stored in the ROM 12 and develops them to the RAM 13; and centrally controls the operations of components of the image forming apparatus 1 according to the developed programs.

The operation displayer 20 is constituted of a displayer 21 and an operator 22.

The displayer 21 is constituted of a liquid crystal display (LCD) and the like; and displays the states of various operation buttons and the apparatus, the operation state of each function and the like on a display screen according to an instruction of a display signal which is input from the controller 10.

The operator 22, which includes various keys such as a ten key and a start key, receives a key operation by a user and outputs its operation signal to the controller 10. In addition, the operator 22, which has a pressure-sensitive (resistance film pressure type) touch panel in which transparent electrodes are arranged in lattice so as to cover an upper surface of the LCD of the displayer 21, detects, as a voltage value, XY coordinates of a force point pressed with a finger, a touch pen, or the like; and outputs a detected position signal to the controller 10 as an operation signal. It should be noted that the touch panel is not limited to a pressure-sensitive one and it may be an electrostatic type, an optical one or the like.

The image processor 30 performs, for input image data (density gradation data) which is input via the communicator 60 and the like, shading correction, color conversion, gradation correction, gradation reproduction processing (screen processing or error diffusion processing) or the like; and outputs the data to the image former 40.

The image former 40 forms an image on a sheet in an electrophotographic system based on the input image data which is input from the image processor 30. In the embodiment, the image former 40 forms a color image by using four-color toner of yellow, magenta, cyan, and black.

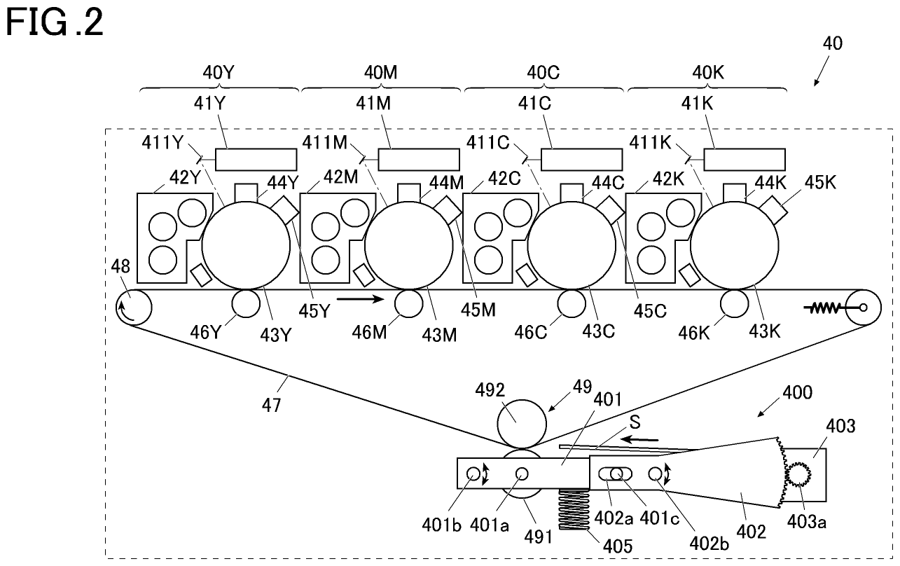

The image former 40 includes as shown in FIG. 2: image forming units 40Y, 40M, 40C, and 40K, an intermediate transfer belt 47, a belt driving roller 48, a secondary transferer 49, and a pressing drive mechanism 400. Reference signs Y, M, C, and K of the units indicate toner colors treated by their respective units and indicate yellow, magenta, cyan, and black, respectively.

The image forming units 40Y, 40M, 40C, and 40K respectively include: exposure units 41Y, 41M, 41C, and 41K; developing units 42Y, 42M, 42C, and 42K; photoreceptor drums 43Y, 43M, 43C, and 43K; chargers 44Y, 44M, 44C, and 44K; cleaners 45Y, 45M, 45C, and 45K; and primary transfer rollers 46Y, 46M, 46C, and 46K. The image forming units 40Y, 40M, 40C, and 40K are arranged side by side at a predetermined interval along a running direction of the intermediate transfer belt 47, as shown in FIG. 2. The image forming units 40Y, 40M, 40C, and 40K each forms a toner image, which is transferred to a sheet by using the intermediate transfer belt 47, on their respective photoreceptor drums 43Y, 43M, 43C, and 43K.

Each of the exposure units 41Y, 41M, 41C, and 41K is constituted of a laser light source such as a laser diode (LD), a polygon mirror (polygon mirror 411Y, 411M, 411C, and 411K), a plurality of lenses, and the like. The exposure units 41Y, 41M, 41C, and 41K perform scanning exposure for surfaces of the photoreceptor drums 43Y, 43M, 43C, and 43K, respectively with a laser beam, based on image data transmitted from the image processor 30. The scanning exposure with a laser beam causes latent images to be formed on the photoreceptor drums 43Y, 43M, 43C, and 43K charged by the chargers 44Y, 44M, 44C, and 44K.

The latent images formed on the photoreceptor drums 43Y, 43M, 43C, and 43K are developed by adhesion of toners of their respective color components by the corresponding developing units 42Y, 42M, 42C, and 42K, thereby forming toner images of the respective color components on the photoreceptor drums 43Y, 43M, 43C, and 43K.

The toner images formed and carried on the photoreceptor drums 43Y, 43M, 43C, and 43K are sequentially transferred to predetermined positions on the intermediate transfer belt 47 by the primary transfer rollers 46Y, 46M, 46C and 46K to which a fixed voltage is applied by an unillustrated power supply, thus primarily transferred. On surfaces of the photoreceptor drums 43Y, 43M, 43C, and 43K where the toner images have been transferred, residual toner is removed by the cleaners 45Y, 45M, 45C, and 45K.

The intermediate transfer belt 47 is a semiconducting endless belt that is suspended and rotatably supported by a plurality of rollers; and is rotationally driven in accordance with the rotation of the rollers. The intermediate transfer belt 47 is rotationally driven in transferring toner images.

The intermediate transfer belt 47 is crimped, by the primary transfer rollers 46Y, 46M, 46C, and 46K, onto their respectively facing photoreceptor drums 43Y, 43M, 43C, and 43K. In each of the primary transfer rollers 46Y, 46M, 46C, and 46K, a transfer current flows depending on the applied voltage. The causes the toner images developed on the surfaces of the respective photoreceptor drums 43Y, 43M, 43C, and 43K to be sequentially transferred (primarily transferred) to the intermediate transfer belt 47 by their respective primary transfer rollers 46Y, 46M, 46C, and 46K.

Meanwhile, in a sheet feeder and a conveyer (both not illustrated), a sheet (indicated by S in FIG. 2) of a kind designated from the controller 10 is fed by the sheet feeder and is conveyed by the conveyer to a transfer position of the secondary transfer roller 491.

The secondary transferer 49 includes the secondary transfer roller 491 and a secondary transfer counter roller 492. The secondary transfer roller 491 rotates by being pressed by the intermediate transfer belt 47, thereby transferring (secondarily transferring) the Y, M, C, and K-colored toner images, which are formed by being transferred to the intermediate transfer belt 47, on the sheet S conveyed from the sheet feeder. The secondary transfer roller 491 is arranged so as to abut on the secondary transfer counter roller 492 via the intermediate transfer belt 47. The sheet S passes through a transfer nip which is formed between the secondary transfer roller 491 and the secondary transfer counter roller 492 and thereby, the toner images on the intermediate transfer belt 47 are secondarily transferred on the sheet S.

After the transfer, the sheet S is conveyed to a fixing unit (not illustrated) and the toner image transferred to the sheet S is thermally fixed. Residual toner on the intermediate transfer belt 47 is removed by the cleaner (not illustrated).

The pressing drive mechanism 400 drives the secondary transfer roller 491 in a driving direction (up-down direction) that is orthogonal to an image transfer surface of a sheet, more specifically, in a crimping direction (upward) to the secondary transfer counter roller 492 (intermediate transfer belt 47) or in separating direction (downward), as shown in FIG. 1 and FIG. 2. The pressing drive mechanism 400 includes a first lever 401, a second lever 402, a motor 403, a sensor 404, and a spring 405.

The first lever 401 rotatably receives the secondary transfer roller 491 by a bearing 401a fixed on the first lever 401. The first lever 401, which is supported by a swing shaft 401b that is inserted through one end (left end in FIG. 2), swings around the swing shaft 401b. At the other end (right end in FIG. 2) of the first lever 401, a shaft member 401c protruding from a surface on a side opposite to the secondary transfer roller 491 is provided.

At one end of the second lever 402, a slide hole 402a extending in a longitudinal direction (left-right direction in FIG. 2) is provided. The first lever 401 and the second lever 402 are connected by insertion of the shaft member 401c of the first lever 401 through the slide hole 402a. In addition, as described above, insertion of the shaft member 401c through the slide hole 402a allows movement of the shaft member 401c in an up-down direction relative to the slide hole 402a to be restricted and permits its movement in a left-right direction. Accordingly, movement of the first lever 401 in an up-down direction relative to the second lever 402 is restricted and also its movement in a left-right direction is permitted.

Since the first lever 401 and the second lever 402 have the above configuration, they move in linkage with each other in an approximately up-down direction; that is, they function as a link mechanism of the present invention in which a driving force is transmitted in both approximately up and down directions. Furthermore, a direction of a load (load direction) applied to a connection point of the link mechanism (first lever 401 and second lever 402) and a moving direction of each component (first lever 401, second lever 402) of the link mechanism at the connection point approximately match. Here, “approximately match” means that a transmission loss of a force between the first lever 401 and the second lever 402 is reduced and a transmission efficiency is within an allowable range; for example, it indicates that the load direction and the moving direction are within ±30°.

The second lever 402, which is supported by a swing shaft 402b that is provided on the other end side with respect to the slide hole 402a, swings around the swing shaft 402b. The other end side with respect to the swing shaft 402b of the second lever 402 is formed so as to be wider toward the other end. The other end of the second lever 402 is formed in an arc shape; and is also formed in a gear shape so as to be engaged with a gear 403a of the motor 403.

The first lever 401, the second lever 402, and the gear 403a transmit a driving force generated by the motor 403 to the secondary transfer roller 491 to drive the secondary transfer roller 491 in the driving direction. That is, the first lever 401, the second lever 402, and the gear 403a function as a transmission mechanism of the present invention.

The motor 403, which is a DC motor capable of controlling a generated torque, causes the gear 403a mounted on the rotation shaft to rotationally move in a normal rotation direction or a reverse rotation direction, thereby generating a driving force for driving the secondary transfer roller 491 in the driving direction. The motor 403 transfers the driving force to the second lever 402 via the gear 403a, thereby rotating the second lever 402.

The sensor 404 is a rotation angle sensor that detects a rotation angle of the motor 403.

The spring (biasing member) 405 has its one end (upper end in FIG. 2) mounted on a side of the other end (right end in FIG. 2) of the first lever 401 with respect to the bearing 401a of the first lever 401 and on a lower surface of the first lever 401; and has the other end (lower end in FIG. 2) fixed on an unmovably fixed mounting surface which is not illustrated. The above configuration allows the spring 405 to bias the first lever 401 upward all the time. The biasing force is transmitted to the secondary transfer roller 491 via the first lever 401, so that the secondary transfer roller 491 is driven all the time in a direction (upper direction in FIG. 2) of pressing the intermediate transfer belt 47. That is, the use of the spring 405 eliminates the necessity of driving the secondary transfer roller 491 all the time in a direction of pressing the intermediate transfer belt 47 by the driving force generated by the motor 403.

The storage 50, which is constituted of a nonvolatile semiconductor memory, hard disk drive (HDD), or the like, stores a system program executable in the image forming apparatus 1, various processing programs executable in the system program, data used in executing these various processing programs, data of processing results obtained by arithmetic processing of the controller 10, and the like.

The communicator 60, which is constituted of a modem, a LAN adaptor, a router, or the like, controls communication with an external device such as a personal computer (PC) connected with a communication network such as a local area network (LAN), wide area network (WAN) or the like so as to perform, for example, reception of image data or the like.

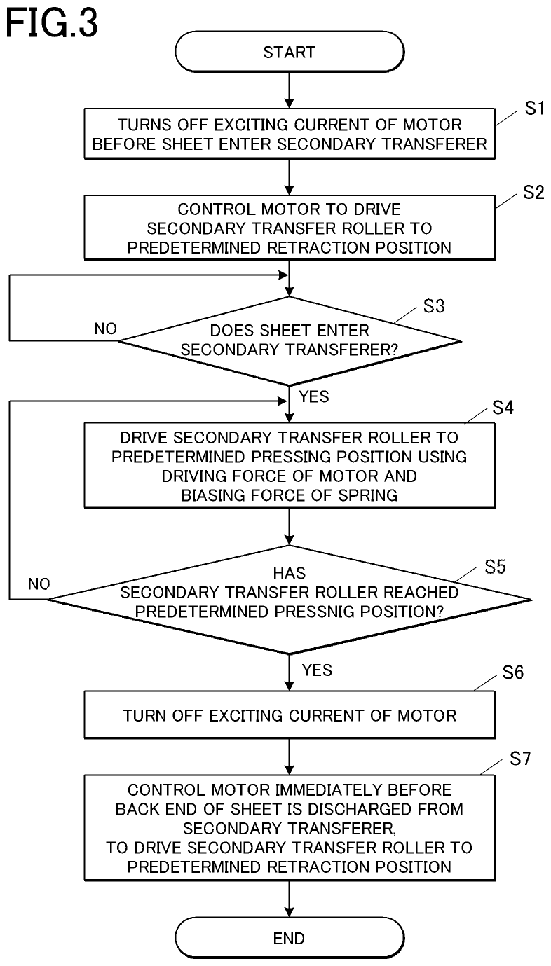

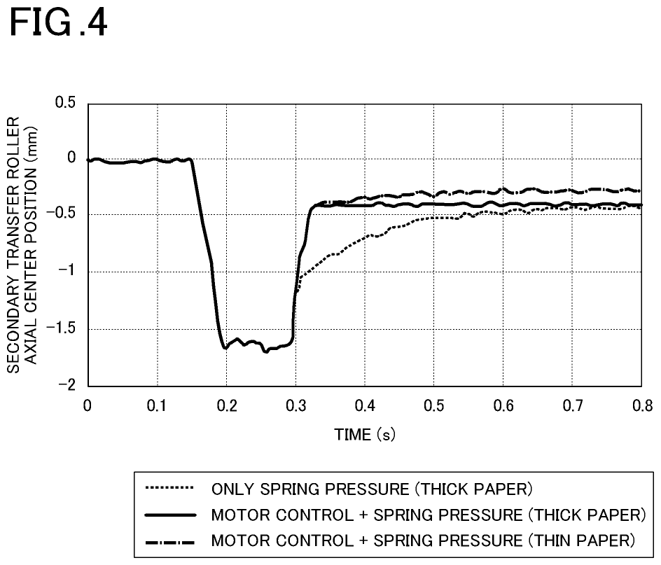

Next, the operation of the image forming apparatus 1 according to the embodiment will be described with reference to FIG. 3 and FIG. 4.

FIG. 3 is a flowchart showing secondary transfer roller driving control processing which is executed by the image forming apparatus 1 when the sheet S enters the secondary transferer 49. The secondary transfer roller driving control processing is implemented by software process in cooperation with programs stored in the CPU 11 and ROM 12 of the controller 10.

FIG. 4 is a graph showing displacement of an axial center position of the secondary transfer roller 491 when the secondary transfer roller driving control processing is executed.

As shown in FIG. 3, first, the controller 10 of the image forming apparatus 1 turns off an exciting current of the motor 403 before the sheet S enters the secondary transferer 49 (step S1).

According to the above control, the secondary transfer roller 491 stops, for example, in a period of 0 s to 0.15 s (during standby) as shown in FIG. 4, at a position (where the secondary transfer roller axial center position shown in FIG. 4 is 0 mm) where a balance between a biasing force (pressing force) by which the spring 405 biases the first lever 401 and a reaction force from the intermediate transfer belt 47 is achieved.

Next, the controller 10 controls the operation amount of the motor 403 so that, for example, as shown in FIG. 4, the secondary transfer roller 491 is retracted by a specified amount (−1.7 mm for the secondary transfer roller axial center position shown in FIG. 4 (1.7 mm downward in FIG. 2)) with respect to the above stopped position of the secondary transfer roller 491, thereby driving the secondary transfer roller 491 to a predetermined retraction position (step S2).

After that, the controller 10 causes a front end of the sheet S to enter the secondary transferer 49 and determines whether the front end of the sheet S has entered the secondary transferer 49, that is, whether the front end of the sheet S has reached the secondary transfer roller 491 (step S3).

At step S3, if determining that the front end of the sheet S has not entered the secondary transferer 49 (step S3; NO), the controller 10 repeatedly performs determination processing of step S3 until determining that the front end of the sheet S has entered the secondary transferer 49.

On the other hand, at step S3, if determining that the front end of the sheet S has entered the secondary transferer 49 (step S3; YES), the controller 10 controls the operation amount of the motor 403 and also drives, by using the biasing force by the spring 405, the secondary transfer roller 491 to a predetermined pressing position (where, for example, the secondary transfer roller axial center position shown in FIG. 4 is −0.4 mm) (step S4). In the embodiment, not only the biasing force by the spring 405 but also the driving force of the motor 403 are controlled to drive the secondary transfer roller 491 to a predetermined pressing position. Therefore, as shown by a dotted line graph in FIG. 4, the secondary transfer roller 491 can be driven to the predetermined pressing position in a shorter time than when the secondary transfer roller 491 is driven to the predetermined pressing position using only the biasing force by the spring.

Here, the predetermined pressing position is set in advance to be a position, for example, that is suitable for pressing a sheet of a thickest paper type that is allowed to pass, that is, a position where vibration can be prevented when the sheet enters the secondary transferer 49. Alternately, the predetermined pressing position may be set in advance to be a position that is suitable for pressing a sheet of a thickest paper type among paper types to be used.

Subsequently, the controller 10 determines whether the secondary transfer roller 491 has reached the predetermined pressing position (step S5).

At step S5, if determining that the secondary transfer roller 419 has not reached the predetermined pressing position (step S5; NO), the controller 10 returns a process to step S4 and repeats subsequent processes.

On the other hand, at step S5, if determining that the secondary transfer roller 419 has reached the predetermined pressing position (step S5; YES), the controller 10 turns off the biasing current of the motor 403. (step S6). That is, after the secondary transfer roller 491 has reached the predetermined pressing position (for example, 0.32 s or after in graphs of a solid line and an alternate long and short dash line in FIG. 4), only the biasing force by the spring 405 works as a driving force for driving the secondary transfer roller 491 to a direction of pressing the intermediate transfer belt 47. Consequently, when the sheet S is thinner than a sheet of a thickest paper type that is allowed to pass, pressing against the sheet S is insufficient immediately after the secondary transfer roller 491 has reached the predetermined pressing position. Therefore, for example, as shown in the alternate long and short dash line graph in FIG. 4, after the secondary transfer roller 491 has reached the predetermined pressing position, the secondary transfer roller 491 is gradually driven in a direction of pressing the intermediate transfer belt 47 by the biasing force by the spring 405.

Subsequently, the controller 10 controls the operation amount of the motor 403 to generate a torque against the biasing force by the spring 405 again immediately before a rear end of the sheet S is discharged from the secondary transferer 49; and causes the secondary transfer roller 491 to retract by a specified amount for discharging the sheet S (step S7), ending the secondary transfer roller driving control processing.

As described above, the pressing drive mechanism 400 of the image forming apparatus 1 according to the embodiment includes: a motor 403 that generates a driving force for driving the secondary transfer roller 491 in a driving direction orthogonal to the image transfer surface of the sheet S; a transmission mechanism (first lever 401, second lever 402, and gear 403a) that transmits a driving force generated by the motor 403 to the secondary transfer roller 491 to drive the secondary transfer roller 491 in the driving direction; the driving controller (controller 10) that controls the driving force of the motor 403 so as to control the position in the driving direction of the secondary transfer roller 491; and the biasing member (spring 405) that biases the secondary transfer roller 491 in the direction of pressing the intermediate transfer belt 47. In addition, the driving controller (controller 10) controls the driving force of the motor 403 in synchronization with a timing at which the front end of the sheet S reaches the secondary transfer roller 491; and causes the secondary transfer roller 491 to be driven to a predetermined pressing position by using the biasing force by the biasing member (spring 405).

Thus, the pressing drive mechanism 400 according to the embodiment controls the driving force of the motor 403 by the driving controller (controller 10) and drives the secondary transfer roller 491 to a predetermined pressing position using the biasing force by the biasing member (spring 405) without providing a distance sensor that detects the position of the secondary transfer roller 491, so that the secondary transfer roller 491 can be driven to the predetermined pressing position at low cost and in a short time, allowing a transfer failure to the sheet S to be prevented.

In addition, the pressing drive mechanism 400 according to the embodiment drives the secondary transfer roller 491 in a direction of pressing the intermediate transfer belt 47 only by the biasing force by the biasing member (spring 405) after the secondary transfer roller 491 has reached the predetermined pressing position, so that power consumption due to driving of the motor 403 can be reduced.

Further, the pressing drive mechanism 400 according to the embodiment sets the predetermined pressing position to be a position for pressing a sheet of a thickest paper type that is allowed to pass, so that application of too much load on the sheet S by the secondary transfer roller 491 can be prevented.

The above detailed description has been given based on the embodiment according to the present invention; however, the present invention is not limited to the above embodiment and various modifications are possible without departing from the spirit and scope thereof.

For example, it may be possible in the above embodiment that a table (not illustrated) in which a pressing position corresponding to each paper type of a sheet is set for the each paper type as the predetermined pressing position described above in advance is stored in the ROM 12 of the controller 10 and the driving controller (controller 10) drives, by using the table, the secondary transfer roller 491 to a pressing position corresponding to the paper type of a sheet S in synchronization with a timing at which the front end of the sheet S reaches the secondary transfer roller 491.

Furthermore, it may be possible in the above embodiment that a measuring unit (measurer) that measures the thickness of a sheet S is provided and the driving controller (controller 10) has the thickness of the sheet S measured by the measuring unit before the front end of the sheet S has reached the secondary transfer roller 491 and drives the secondary transfer roller 491 to a predetermined pressing position corresponding to the thickness of the sheet S in synchronization with a timing at which the front end of the sheet S reaches the secondary transfer roller 491.

In the above embodiment, for example, an example of using a ROM as a computer-readable medium in which programs for executing various processes are stored is disclosed; however, there is no limitation thereto. As an alternate computer readable medium, a nonvolatile memory such as a flash memory or a portable recording medium such as a CD-ROM can be applied. In addition, as a medium for providing program data via a communication line, a carrier wave may be applied.

Although embodiments of the present invention have been described and illustrated in detail, the disclosed embodiments are made for purposes of illustration and example only and not limitation. The scope of the present invention should be interpreted by terms of the appended claims.

What is claimed is:

1. A pressing drive mechanism that drives a secondary transfer roller to press an intermediate transfer belt, the secondary transfer roller secondarily transferring a toner image on a sheet by being pressed and rotated by the intermediate transfer belt on which the toner image is primarily transferred, the pressing drive mechanism comprising:
a motor that generates a driving force for driving the secondary transfer roller in a driving direction, the driving direction being a direction orthogonal to an image transfer surface of the sheet;
a transmission mechanism that transmits the driving force generated by the motor to the secondary transfer roller to drive the secondary transfer roller in the driving direction;
a hardware processor that controls the driving force of the motor so as to control a position in the driving direction of the secondary transfer roller; and
a biasing member that biases the secondary transfer roller in a direction of pressing the intermediate transfer belt; wherein
the hardware processor controls the driving force of the motor in synchronization with a timing at which a front end of the sheet reaches the secondary transfer roller, and drives the secondary transfer roller to a predetermined pressing position by using a biasing force by the biasing member.

2. The pressing drive mechanism according to claim 1, wherein
the hardware processor drives the secondary transfer roller in a direction of pressing the intermediate transfer belt only by the biasing force by the biasing member after the secondary transfer roller reaches the predetermined pressing position.

3. The pressing drive mechanism according to claim 1; wherein
the predetermined pressing position is a position for pressing either a sheet of a thickest paper type that is allowed to pass or a sheet of a thickest paper type among paper types to be used.

4. The pressing drive mechanism according to claim 1, wherein
a pressing position corresponding to each paper type of the sheet is set in advance for the each paper type as the predetermined pressing position; and
the hardware processor drives the secondary transfer roller to the pressing position corresponding to the paper type of the sheet in synchronization with a timing at which the front end of the sheet reaches the secondary transfer roller.

5. The pressing drive mechanism according to claim 1, comprising:
a measurer that measures a thickness of the sheet; wherein
the hardware processor drives the secondary transfer roller to the predetermined pressing position corresponding to the thickness of the sheet in synchronization with a timing at which the front end of the sheet reaches the secondary transfer roller.

6. An image forming apparatus comprising:
an intermediate transfer belt to which a toner image is primarily transferred;
a secondary transfer roller that secondarily transfers the toner image to a sheet by being pressed and rotated by the intermediate transfer belt;
an image forming unit that forms a toner image on a photoreceptor drum, the toner image being secondarily transferred to the sheet by using the intermediate transfer belt and the secondary transfer roller; and
the pressing drive mechanism according to claim 1 that drives the secondary transfer roller to press the intermediate transfer belt.
